(19) United States
(12) Patent Application Publication
(10) Pub. No.: US 2017/0145906 A1
(43) Pub. Date: May 25, 2017

(54) SUPERCHARGING SYSTEM

(71) Applicant: TOYOTA JIDOSHA KABUSHIKI KAISHA, Toyota-shi, Aichi-ken (JP)

(72) Inventors: Sho TOMITA, Susono-shi (JP); Tomomi YAMADA, Suntoh-gun (JP)

(73) Assignee: TOYOTA JIDOSHA KABUSHIKI KAISHA, Toyota-shi, Aichi-ken (JP)

(21) Appl. No.: 15/320,041

(22) PCT Filed: Jun. 29, 2015
(86) PCT No.: PCT/JP2015/069364

§ 371 Date: Dec. 19, 2016

(30) Foreign Application Priority Data
Jun. 30, 2014 (JP) 2014-134010

(51) Int. Cl. F02B 37/14; F02D 41/18; F02D 41/00; F02B 37/10; F02B 37/16

(52) U.S. Cl. CPC F02B 37/14; F02B 37/10; F02B 37/16; F02D 41/0007; F02D 41/18; F02D 2200/0406; F02D 2200/101

(57) ABSTRACT

A supercharging system 1 is changed over between a single stage supercharging mode in which an internal combustion engine 2 is supercharged only by a single turbo charger 3, and a two stage supercharging mode in which the internal combustion engine 2 is supercharged both by the turbo charger 3 and also by an electric supercharger 4. And the threshold values for a parameter that is used for operating a bypass valve 13 are different for the case in which closing operation of the bypass valve 13 is performed in order to change over from the single stage supercharging mode to the two stage supercharging mode, and for the case in which opening operation of the bypass valve 13 is performed in order to change over from the two stage supercharging mode to the single stage supercharging mode.

### TECHNICAL FIELD

The present invention relates to a supercharging system that is applied to an internal combustion engine, and that includes a turbo charger that is powered by the engine exhaust and also an electric supercharger that is powered by electricity.

### BACKGROUND ART

As a supercharging system applied to an internal combustion engine, a system is per se known that comprises both a turbo charger and also an electric supercharger, and with which the response delay of the turbo charger during acceleration is improved by the action of the electrically supercharging (refer to Patent Document #1).

### CITATION LIST

### Patent Literature

Patent Document #1: JP2004-251248A.

### SUMMARY OF INVENTION

### Technical Problem

With the supercharging system of Patent Document #1, it is possible to implement both a two stage supercharging mode in which supercharging of the internal combustion engine is performed both with the turbo charger and also with the electric supercharger, and a single state supercharging mode in which supercharging of the internal combustion engine is performed only with the turbo charger. However, if the two stage supercharging mode is implemented, not only during acceleration, but during steady operation or during quasi-steady operation that can be viewed as being steady operation, then hunting can easily occur in the vicinity of the changeover condition where the state of the system during steady operation or during quasi-steady operation changes over between the single stage supercharging mode and the two stage supercharging mode. In particular, in the case of a structure in which a bypass passage that bypasses the electric supercharger is provided and this bypass passage is opened and closed by a bypass valve along with the changeover of supercharging mode, there is a possibility that fluctuations of the output torque of the internal combustion engine will be generated due to the intake air amount changing directly along with opening and closing of the bypass passage.

Accordingly, the object of the present invention is to provide a supercharging system that is capable of suppressing the occurrence of hunting along with changeover of the supercharging mode.

### Solution to Technical Problem

The supercharging system of the present invention is a supercharging system applied to an internal combustion engine, comprising: a turbo charger that is driven by a turbine powered by an exhaust of the engine; an electric supercharger that is electrically powered; a bypass passage that bypasses the electric supercharger and connects an upstream side and a downstream side of the electric supercharger; a bypass valve that is provided for opening and closing the bypass passage, and that operates between an open position in which it opens the bypass passage and a closed position in which it closes the bypass passage; and a supercharging control device that changes over the supercharging mode between: a single stage supercharging mode in which the internal combustion engine is only supercharged by the turbo charger, due to electrical driving of the electric supercharger being stopped with the bypass valve in the open position; and a two stage supercharging mode in which the internal combustion engine is supercharged by both the turbo charger and the electric supercharger, due to electrical driving of the electric supercharger being performed with the bypass valve in the closed position; wherein the threshold values of a parameter that is employed for operating the bypass valve are different between a case of closing operation in which the bypass valve is operated from the open position to the closed position in order to change over from the single stage supercharging mode to the two stage supercharging mode, and a case of opening operation in which the bypass valve is operated from the closed position to the open position in order to change over from the two stage supercharging mode to the single stage supercharging mode.

According to this supercharging system, since the operation of opening the bypass valve and the operation of closing the bypass valve in order to change over the supercharging mode are performed with different threshold values, accordingly, during steady operation or quasi-steady operation, it is possible to suppress the occurrence of hunting, which is caused by frequent opening operation and closing operation of the bypass valve.

As an aspect of the supercharging system of the present invention, the threshold values for the parameter that is employed for operating the bypass valve may be different between the case of closing operation in which the bypass valve is operated from the open position to the closed position in order to change over from the single stage supercharging mode to the two stage supercharging mode, and the case of opening operation in which the bypass valve is operated from the closed position to the open position in order to change over from the two stage supercharging mode to the single stage supercharging mode, during steady operation or quasi-steady operation in which change over time of an operational state of the internal combustion engine is within a predetermined range. According to this aspect, the operation of opening the bypass valve and the operation of closing the bypass valve in order to change over the supercharging mode are performed with different threshold values, only during steady operation or during quasi-steady operation. Therefore, during steady operation or quasi-steady operation, it is possible to suppress the occurrence of hunting, which is caused by frequent opening operation and closing operation of the bypass valve. And, in any operational state other than during steady operation or quasi-steady operation, it is possible to employ control that is appropriately adapted to that operational state.

As an aspect of the supercharging system of the present invention, the parameter may be a rotational speed, an intake air amount, or a boost pressure of the internal combustion engine; and the threshold value for the parameter for implementing the opening operation of the bypass valve may be smaller than the threshold value for the parameter for implementing the closing operation of the bypass valve. According to this aspect, when the closing operation of the bypass valve has been implemented and transition has taken place from the single stage supercharging mode to the two stage supercharging mode, even when subsequently the value of the parameter arrives at the threshold value at which the closing operation was implemented, the two stage supercharging mode is maintained without implementing opening operation of the bypass valve. And when the value of the parameter has arrived at a threshold value that is smaller than the threshold value at which the closing operation was implemented, the opening operation of the bypass valve is implemented and transition takes place from the two stage supercharging mode to the single stage supercharging mode. Accordingly, it is possible to suppress the occurrence of hunting, which is caused by frequent opening operation and closing operation of the bypass valve.

As an aspect of the supercharging system of the present invention, if driving in the two stage supercharging mode has continued for longer than a predetermined time interval with a value of the parameter being between the threshold value for the parameter for implementing the opening operation of the bypass valve and the threshold value for the parameter for implementing the closing operation of the bypass valve, then the supercharging control device may implement stopping of electrical driving of the electric supercharger, and also implements the opening operation of the bypass valve. According to this aspect, since it is possible to avoid the two stage supercharging mode continuing between the two threshold values over a long time period, accordingly it is possible to reduce the amount of electrical power consumption entailed by the electrical driving of the electric supercharger.

As an aspect of the supercharging system of the present invention, there may be further included a turbine bypass passage that bypasses the turbine of the turbo charger and connects between an upstream side and a downstream side of the turbine, and a wastegate valve that is provided in the turbine bypass passage and is capable of varying its opening amount from a position in which it fully closes the turbine bypass passage and a position in which it fully opens the turbine bypass passage; and in this case, when driving in the two stage supercharging mode is implemented between the threshold value for the parameter for implementing the opening operation of the bypass valve and the threshold value for the parameter for implementing the closing operation of the bypass valve, then the supercharging control device may adjust a boost pressure by operating the wastegate valve. According to this aspect, it is possible to adjust the boost pressure by operating the wastegate valve when driving in the two stage supercharging mode between the two threshold values is implemented.

As an aspect of the supercharging system of the present invention, there may be further included a turbine bypass passage that bypasses the turbine of the turbo charger and connects between an upstream side and a downstream side of the turbine, and a wastegate valve that is provided in the turbine bypass passage and is capable of varying its opening amount from a position in which it fully closes the turbine bypass passage and a position in which it fully opens the turbine bypass passage; and in this case, when driving in the two stage supercharging mode is implemented between the threshold value for the parameter for implementing the opening operation of the bypass valve and the threshold value for the parameter for implementing the closing operation of the bypass valve, then the supercharging control device may adjust a boost pressure by operating the electric supercharger, while keeping an operational state of the wastegate valve in the position in which it fully closes the turbine bypass passage. According to this aspect, by fully closing the turbine bypass passage when driving in the two stage supercharging mode is implemented between the threshold values, it is possible to adjust the boost pressure by operating the electric supercharger, while increasing the allocation of supercharging by the electric supercharger.

In this aspect, if the operational state of the wastegate valve in the position in which it fully closes the turbine bypass passage has continued for longer than a predetermined time interval, then the supercharging control device increases a rotational speed of the electric supercharger, and, after having operated the wastegate valve towards its open side so that an increase of the boost pressure due to this increase of the rotational speed of the electric supercharger is cancelled, may then simultaneously stop the electrical driving of the electric supercharger and performs opening operation of the bypass valve. According to this aspect, since the increase of the boost pressure accompanying increase of the rotational speed of the electric supercharger is cancelled, accordingly it is possible to change over the supercharging mode from the two stage supercharging mode to the single stage supercharging mode by simultaneously implementing stopping of electrical driving of the electric supercharger and opening operation of the bypass valve, while suppressing fluctuations of the output torque of the internal combustion engine.

### BRIEF DESCRIPTION OF DRAWINGS

FIG. 1 is a figure schematically showing the overall structure of an internal combustion engine that is equipped with a supercharging system according to an embodiment of the present invention;

FIG. 2 is an explanatory figure showing a changeover of supercharging mode;

FIG. 3 is a flow chart showing an example of a control routine according to a first embodiment;

FIG. 4 is a timing chart showing an example of control results obtained with this first embodiment;

FIG. 5 is a flow chart showing an example of a control routine according to a second embodiment;

FIG. 6 is a timing chart showing an example of control results obtained with this second embodiment;

FIG. 7 is a flow chart showing an example of a control routine according to a third embodiment; and

FIG. 8 is a timing chart showing an example of control results obtained with this third embodiment.

### DESCRIPTION OF EMBODIMENTS

### Embodiment #1

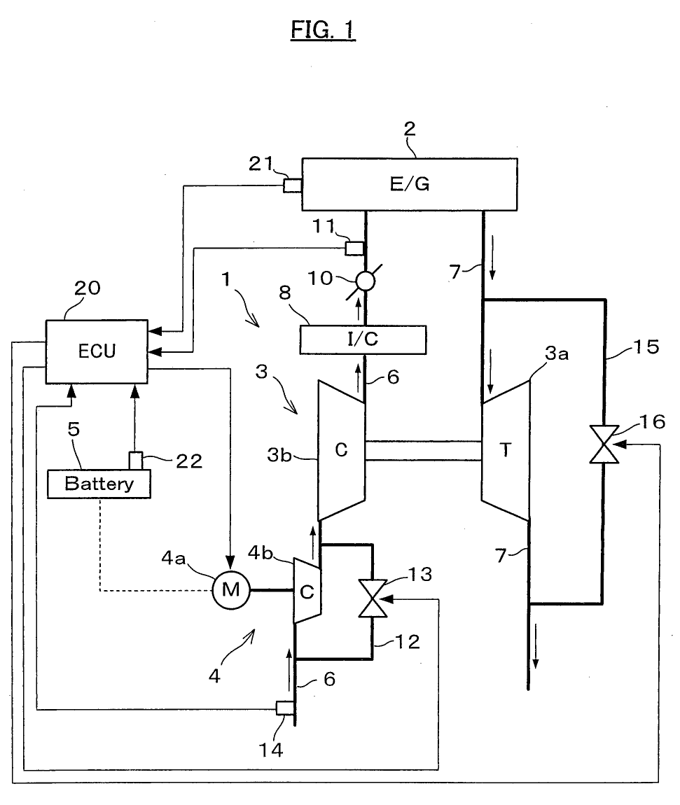

As shown in FIG. 1, this supercharging system 1 is applied to an internal combustion engine 2. This internal combustion engine 2 is built as a spark ignition type internal combustion engine that is mounted to an automobile not shown in the figures and serves as a power source for traveling. The supercharging system 1 comprises a turbo charger 3 and an electric supercharger 4, both of which supercharge the internal combustion engine 1. The turbo charger 3 comprises a turbine 3a that receives exhaust gas from the internal combustion engine 2 and a compressor 3b that is driven by the turbine 3a. And the electric supercharger 4 comprises an electric motor 4a and a compressor 4b that is driven by the motor 4a. The electric motor 4a is connected to a battery 5, so that electrical power from the battery 5 is employed as power for driving the electric motor 4a.

The compressor 3b of the turbo charger 3 is provided in an intake passage 6, while its turbine 3a is provided in an exhaust passage 7. An intercooler 8 that cools the air pressurized by the compressor 3b and a throttle valve 10 that adjusts the air flow amount are provided in the intake passage 6 at the downstream side of the compressor 3b. And a pressure sensor 11 that outputs a signal corresponding to the boost pressure (i.e. to the intake pressure) of the internal combustion engine 2 is provided at the downstream side of the throttle valve 10. The compressor 4b of the electric supercharger 4 is provided in the intake passage 6 at the upstream side of the compressor 3b of the turbo charger 3. A bypass passage 12 is provided in the intake passage 6, and this passage 12 bypasses the electric supercharger 4 by connecting an upstream side of the electric supercharger 4 to its downstream side. A bypass valve 13 for opening and closing the bypass passage 12 is provided in the bypass passage 12. The bypass valve 13 operates between an open position in which it opens the bypass passage 12 and a closed position in which it closes the bypass passage 12. The position where the downstream side of the bypass passage 12 is connected is located between the compressor 4b of the electric supercharger 4 and the compressor 3b of the turbo charger 3. On the other hand, the position where the upstream side of the bypass passage 12 is connected is located between the compressor 4b of the electric supercharger 4 and an air flow meter 14. The air flow meter 14 is a per se known sensor that outputs a signal corresponding to the magnitude of the flow of intake air.

A turbine bypass passage 15 that bypasses the turbine 3a of the turbo charger 3 by connecting the upstream side of the turbine 3a to its downstream side, and a wastegate valve 16 that adjusts the flow rate of exhaust flowing through this turbine bypass passage 15, are provided to the supercharging system 1 in order to adjust the boost pressure of the internal combustion engine 2. The wastegate valve 16 is of a type that is sometimes termed an active wastegate valve, and is built as an electromagnetically operated valve that is capable of varying its opening amount from a fully closed position in which it fully closes the turbine bypass passage 15 to a fully open position in which it fully opens the turbine bypass passage 15. It is thus possible to vary the flow rate of the exhaust flowing through the turbine bypass passage 15 and the turbine 3a by varying the opening amount of the wastegate valve 16. Since the output of the compressor 3b is varied by doing this, accordingly it is thereby possible to adjust the boost pressure of the internal combustion engine 2.

An engine control unit (ECU) 20 that is configured as a computer for controlling the internal combustion engine 2 is provided to the supercharging system 1. Apart from controlling various operational parameters of the internal combustion engine 2 in an adequate manner, such as the ignition timing and the fuel injection amount and so on, the ECU 20 also implements control for the supercharging system 1 corresponding to the present invention. Signals from a large number of sensors are inputted to the ECU 20 in order to obtain necessary information for implementing control of various kinds. As sensors that relate to the present invention, apart from the pressure sensor 11 and the air flow meter 14 described above, there are also provided a crank angle sensor 21 that outputs a signal corresponding to the rotational speed of the internal combustion engine 2 and a SOC sensor 22 that outputs a signal corresponding to the charge ratio of the battery 5 and so on, and the signals from these sensors are inputted to the ECU 20.

The ECU 20 changes over the supercharging mode of the supercharging system 1 between a single stage supercharging mode and a two stage supercharging mode. The single stage supercharging mode is a supercharging mode in which, with the bypass valve 13 in the open position, the turbo charger 3 only supercharges the internal combustion engine 2, due to the electrical driving of the electric supercharger 4 being stopped. On the other hand, the two stage supercharging mode is a supercharging mode in which, with the bypass valve 13 in the closed position, the turbo charger 3 and the electric supercharger 4 both supercharge the internal combustion engine, due to the electric supercharger 4 being electrically driven.

Control adapted to the operational state of the internal combustion engine 2 is employed for changing over between these supercharging modes. For example, during transient operation in which the rate of change of the operational state of the internal combustion engine 2, in other words the rate of change of the engine rotational speed and of the vehicle speed, is greater than a predetermined range, if the deviation between the target boost pressure and the actual boost pressure is greater than a predetermined reference value, then electrical driving of the electric supercharger 4 is implemented in order to supplement the supercharging response delay of the turbo charger 3, so that changeover of the supercharging mode is performed from the single stage supercharging mode to the two stage supercharging mode. Furthermore, the two stage supercharging mode is started from the moment when the accelerator pedal is depressed in the non-supercharging state, and when the pressure approaches the target boost pressure, then changeover of the supercharging mode from the two stage supercharging mode to the single stage supercharging mode is performed. During this type of transient operation, the boost pressure is adjusted by feedback controlling the opening amount of the wastegate valve 16 in the direction to reduce the deviation between the target boost pressure and the actual boost pressure.

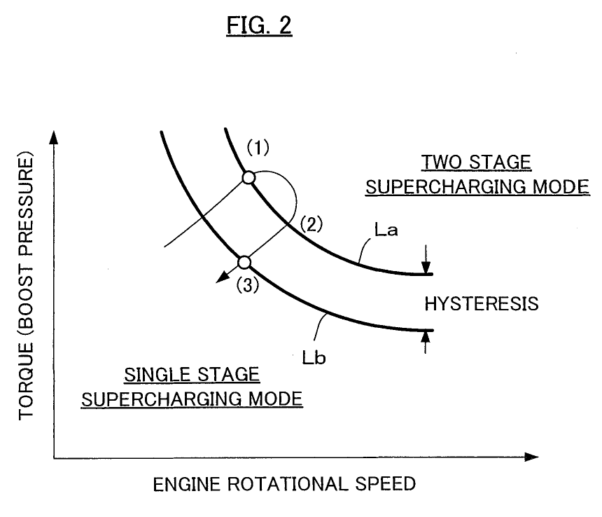

On the other hand, during steady operation or quasi-steady operation when the rate of change of the operational state of the internal combustion engine 2 is within the predetermined range, changeover of the supercharging mode is implemented on the basis of a supercharging mode changeover map such as, for example, the one shown in FIG. 2. The predetermined range for distinguishing between the state of steady or quasi-steady operation and the state of transient operation is set in an appropriate manner according to the characteristics of the internal combustion engine 2. Two changeover lines La and Lb are set in the changeover map of FIG. 2, defined by the rotational speed of the internal combustion engine 2 (i.e. by engine rotational speed) and by torque (i.e. by boost pressure). The first of these changeover lines La is used when changing over from the single stage supercharging mode to the two stage supercharging mode. On the other hand, the other of these changeover lines Lb is set more toward the low rotational speed low torque (i.e. low boost pressure) side than the changeover line La, and is used when changing over from the two stage supercharging mode to the single stage supercharging mode. In other words, in the supercharging system 1 of this embodiment, different threshold values are used for changing over the supercharging mode, depending upon the direction of change of the supercharging mode. To put this in yet another manner, a certain hysteresis is set in relation to the change of supercharging mode.

As shown in FIG. 2, when the operational state of the internal combustion engine 2 changes along the solid line shown by the arrow sign, at the state (1) when the operational state arrives at the changeover line La, the bypass valve 13 is changed over from the open position to the closed position, and the system transitions to the two stage supercharging mode. And thereafter, at the state (2) in which the operational state reaches the changeover line La for a second time, the two stage supercharging mode is maintained without alteration, until at the state (3) in which the operational state reaches the changeover line Lb the bypass valve 13 is changed over from the closed position to the open position, and the system transitions to the single stage supercharging mode. Since this type of hysteresis is set in relation to changeover of the supercharging mode, accordingly, even in the state in which the torque (i.e. the boost pressure) changes during steady operation or during quasi-steady operation, it is possible to suppress hunting which might otherwise be caused by frequent fluctuations of the intake air amount due to frequent opening and closing of the bypass valve 13.

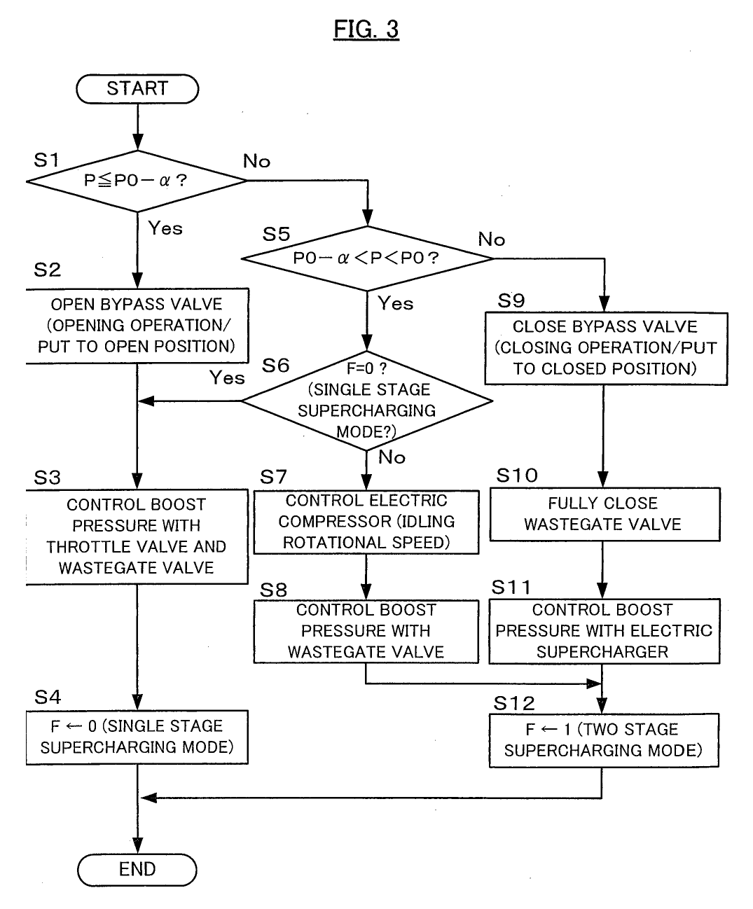

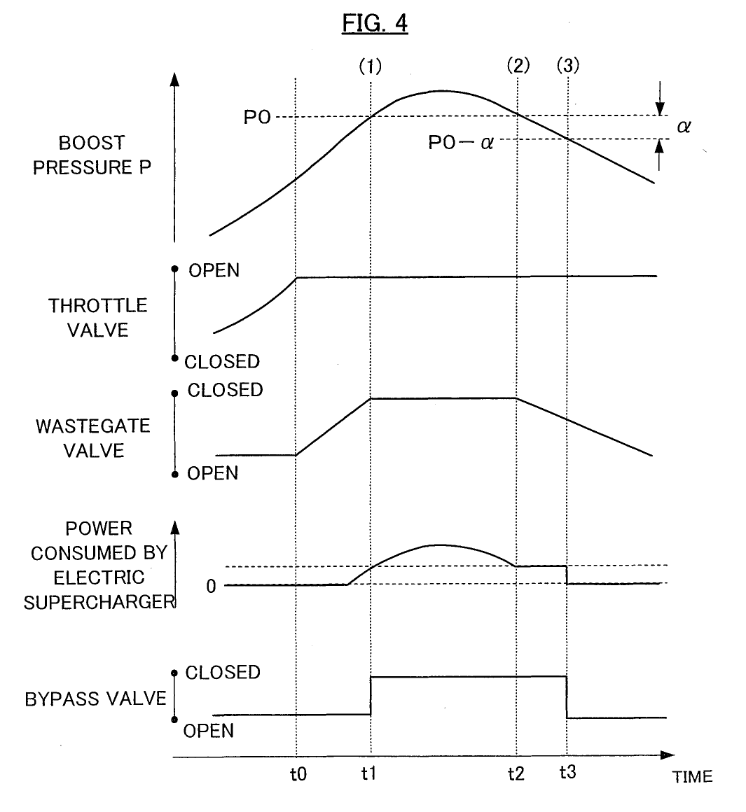

Next, the processing implemented by the ECU 20 in this embodiment will be explained in concrete terms with reference to FIGS. 3 and 4. It should be understood that while, in the control according to this embodiment explained below, the boost pressure is employed as one example of the parameter that is used for operating the bypass valve 13, it would also be possible to change the control according to this embodiment to a method in which the engine rotational speed is also used as a parameter along with the boost pressure, as explained in FIG. 2.

The program of the control routine shown in FIG. 2 is read out from storage by the ECU 20 in a timely manner and is repeatedly executed at predetermined intervals. In a step S1, the ECU 20 refers to the signal from the pressure sensor 11, and makes a decision as to whether or not the current boost pressure P is less than or equal P0−α, which is a value that is less than a threshold value P0 by a hysteresis amount α. P0 is equivalent to a threshold value for implementing closing operation of the bypass valve 13 in order to change over from the single stage supercharging mode to the two stage supercharging mode, while P0−α is equivalent to a threshold value for implementing opening operation of the bypass valve 13 in order to change over from the two stage supercharging mode to the single stage supercharging mode. If the boost pressure P is less than or equal P0−α then the flow of control proceeds to a step S2, whereas if it is not, then the flow of control is transferred to a step S5.

In the step S2, the ECU 20 controls the bypass valve 13 so as to put it to the open position. In a step S3, the ECU 20 controls the boost pressure to a target value by controlling the opening amounts of the throttle valve 10 and of the wastegate valve 16. It should be understood that the target value for the boost pressure is calculated repeatedly in a cycle by a control routine (not shown in the figures) that runs in parallel with the control routine of FIG. 3 on the basis of parameters of the internal combustion engine 2 such as the rotational speed and the load and so on. And next in a step S4 the ECU 20 sets a management flag F for managing the current state of the supercharging mode to “0”, which means the single stage supercharging mode.

In the step S5, the ECU 20 makes a decision as to whether or not the boost pressure P is greater than P0−α and also is smaller than P0. In other words, the ECU makes a decision as to whether or not the boost pressure P is within the hysteresis range (i.e. the neutral zone). If indeed the boost pressure P is greater than P0−α and also is smaller than P0, then the flow of control proceeds to a step S6, whereas if it is not, in other words if the boost pressure P has reached the threshold value P0, then the flow of control is transferred to a step S9.

In the step S6, the ECU 20 makes a decision as to whether or not the current supercharging mode is the single stage supercharging mode, in other words as to whether or not the flag F=0. If the current mode is the single stage supercharging mode then the flow of control is transferred to the step S3, whereas if it is not, in other words if the current mode is the two stage supercharging mode, then the flow of control proceeds to a step S7.

In the step S7, the ECU 20 acquires the intake air amount on the basis of the signal from the air flow meter 14, and, on the basis of this intake air amount, controls the electric supercharger 4 so that it is kept at an idling rotational speed at a level at which there is no intake resistance. In a step S8, the ECU 20 controls the opening amount of the wastegate valve 16 to the open side, and thereby adjusts the boost pressure.

In the step S9, the ECU 20 controls the bypass valve 13 to the closed position. In a step S10, the ECU 20 controls the wastegate valve 16 to the fully closed state. In a step S11, the ECU 20 controls the boost pressure by operating the electric supercharger 4 as appropriate. In a step S12, the ECU 20 sets the management flag F to “1”, which means the two stage supercharging mode.

An example of the control results provided by the control routine of FIG. 3 will now be explained on the basis of the timing chart shown in FIG. 4. As shown in FIG. 4, from the time point t0, the opening amount of the throttle valve 10 becomes almost constant, so that the vehicle is operating in a stationary state or a quasi-stationary state. Thereafter, the boost pressure P is raised as the ECU 20 controls the opening amount of the wastegate valve 16 toward the closed side. And, when the boost pressure P reaches the threshold value P0 at the time point t1, the bypass valve 13 performs closing operation from its open position to its closed position, and is kept at its closed position until the time point t3 (refer to the step S9 of FIG. 3). And, due to the electric supercharger 4 being driven electrically, the supercharging mode transitions to the two stage supercharging mode. It should be understood that, in consideration of the response delay of the electric supercharger 4 for performing supercharging, the timing for starting electrical driving of the electric supercharger 4 is set to be a little earlier than the time point t1 at which the boost pressure P arrives at P0.

When, after having gone back to decreasing after having become higher than the threshold value P0 at the time point t1, the boost pressure P becomes lower than the threshold value P0 at the time point t2, the electric supercharger 4 is controlled to an idling rotational speed at a level at which the electric supercharger 4 has no substantial intake resistance (refer to the step S7 of FIG. 3), until the boost pressure P reaches P0−α at the time point t3. And at the same time the boost pressure is adjusted by the wastegate valve 16 being operated from fully closed toward the open side (refer to the step S8 of FIG. 3). When the boost pressure P reaches P0−α at the time point t3, the bypass valve 13 is operated to open from its closed position to its open position (refer to the step S2 of FIG. 3), and at the same time the electrical driving of the electric supercharger 4 is stopped, so that the supercharging mode transitions from the two stage supercharging mode to the single stage supercharging mode.

According to this first embodiment, on the one hand the closing operation of operating the bypass valve 13 from its open position to its closed position in order to change over the supercharging mode from the single stage supercharging mode to the two stage supercharging mode is performed at the threshold value P0, while on the other hand the opening operation of operating the bypass valve 13 from its closed position to its open position in order to change over the supercharging mode from the two stage supercharging mode to the single stage supercharging mode is performed at the threshold value P0−α, so that the opening operation and the closing operation for the bypass valve 13 are performed with different threshold values. Due to this, it is possible to suppress the occurrence of hunting, which is caused by frequent opening operation and closing operation of the bypass valve 13 during steady operation or during quasi-steady operation. In this first embodiment, the ECU 20 functions as the “supercharging control device” of the Claims by executing the control routine of FIG. 3.

### Embodiment #2

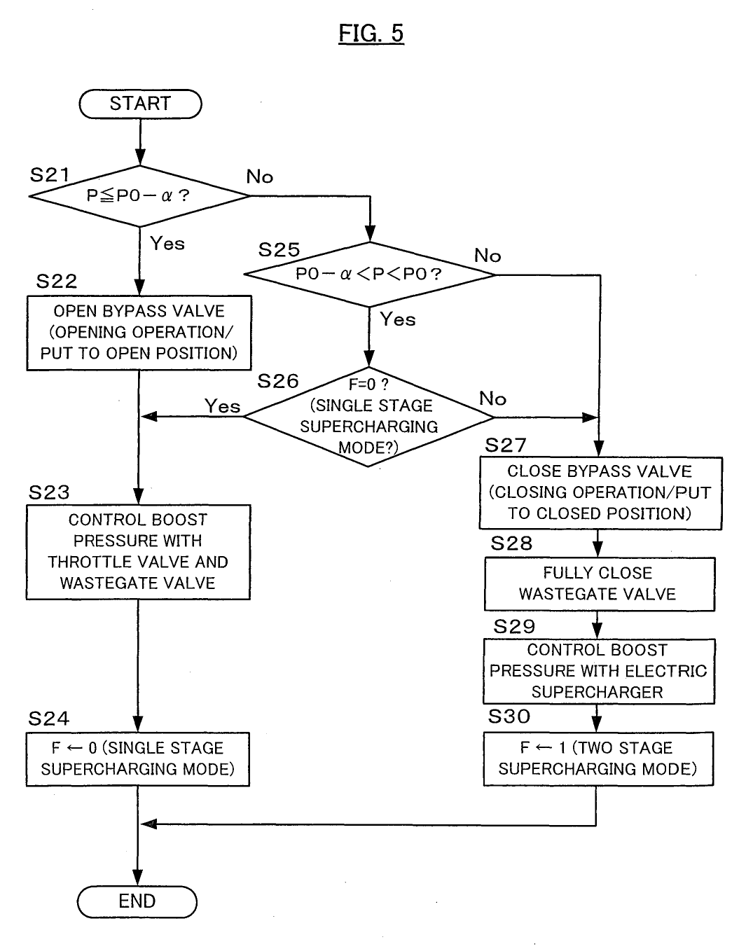

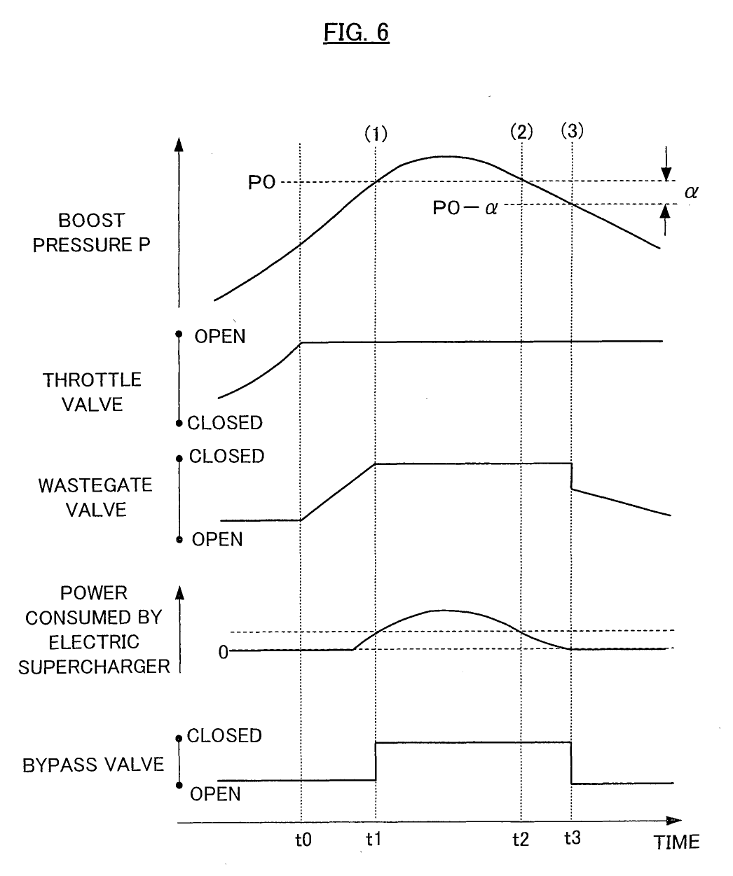

Next, a second embodiment of the present invention will be explained with reference to FIG. 5 and FIG. 6. Since this second embodiment is the same as the first embodiment except for the details of the control, accordingly reference should be made to FIG. 1 for the physical structure of this second embodiment, and the explanation of the first embodiment should be referred to for explanation of that physical structure.

The program of the control routine shown in FIG. 5 is read out from storage by the ECU 20 in a timely manner and is repeatedly executed at predetermined intervals. In a step S21, the ECU 20 refers to the signal from the pressure sensor 11, and makes a decision as to whether or not the current boost pressure P is less than or equal P0−α, which is a value that is less than a threshold value P0 by a hysteresis amount α. If the boost pressure P is less than or equal P0−α then the flow of control proceeds to a step S22, whereas if it is not then the flow of control is transferred to a step S25.

In the step S22, the ECU 20 controls the bypass valve 13 so as to put it to the open position. In a step S23, the ECU 20 controls the boost pressure to a target value by controlling the opening amounts of the throttle valve 10 and of the wastegate valve 16. In a step S24, the ECU 20 sets a management flag F to “0”, which means the single stage supercharging mode.

In the step S25, the ECU 20 makes a decision as to whether or not the boost pressure P is greater than P0−α and also is smaller than P0. If indeed the boost pressure P is greater than P0−α and also is smaller than P0, then the flow of control proceeds to a step S26, whereas if it is not, in other words if the boost pressure P has reached the threshold value P0, then the flow of control is transferred to a step S27.

In the step S26, the ECU 20 makes a decision as to whether or not the current supercharging mode is the single stage supercharging mode, in other words as to whether or not the flag F=0. If the current mode is the single stage supercharging mode then the flow of control is transferred to the step S23, whereas if it is not, in other words if the current mode is the two stage supercharging mode, then the flow of control proceeds to the step S27.

In the step S27, the ECU 20 controls the bypass valve 13 to the closed position. In a step S28, the ECU 20 controls the opening amount of the wastegate valve 16 to the fully closed state. In a step S29, the ECU 20 controls the boost pressure by operating the electric supercharger 4 as appropriate. In a step S30, the ECU 20 sets the management flag F to “1”, which means the two stage supercharging mode.

An example of the control results provided by the control routine of FIG. 5 will now be explained on the basis of the timing chart shown in FIG. 6. As shown in FIG. 6, from the time point t0, the opening amount of the throttle valve 10 becomes almost constant, so that the vehicle is operating in a stationary state or a quasi-stationary state. Thereafter, the boost pressure P rises due to the wastegate valve 16 being controlled toward the closed side. And, when the boost pressure P reaches the threshold value P0 at the time point t1, the bypass valve 13 performs closing operation from its open position to its closed position, and is kept at its closed position until the time point t3 (refer to the step S27 of FIG. 5). And, due to the electric supercharger 4 being driven electrically, the supercharging mode transitions to the two stage supercharging mode. It should be understood that, in consideration of the response delay of the electric supercharger 4 for performing supercharging, the timing for starting electrical driving of the electric supercharger 4 is set to be a little earlier than the time point t1 at which the boost pressure P arrives at P0.

After the boost pressure P has reached P0 at the time point t1 and the system has transitioned to the two stage supercharging mode, the wastegate valve 16 is kept in its fully closed state until the boost pressure P reaches P0−α at the time point t3, and during this interval the boost pressure by the electric supercharger 4 is controlled (refer to the step S29 of FIG. 5) so that the electric supercharger 4 becomes an intake resistance. And, when the boost pressure P reaches P0−α at the time point t3, the bypass valve 13 is operated to open from its closed position to its open position (refer to the step S22 of FIG. 5), and at the same time the electrical driving of the electric supercharger 4 is stopped, so that the supercharging mode transitions from the two stage supercharging mode to the single stage supercharging mode.

According to this second embodiment, in a similar manner to the case with the first embodiment, since the opening operation and the closing operation of the bypass valve 13 are performed at threshold values that are different from one another, accordingly it is possible to suppress the occurrence of hunting, which is caused by frequent opening and closing operation of the bypass valve 13 during steady operation or during quasi-steady operation. Moreover, while in the first embodiment control of the electric supercharger 4 was performed so as to keep it at its idling rotational speed, in this second embodiment, control of the electric supercharger 4 is not performed so as to keep it at its idling rotational speed; rather, while keeping the wastegate valve 16 in its fully closed state, the electric supercharger 4 is controlled so that it becomes an intake resistance. Due to this, it is possible to keep down the amount of electrical power consumed by driving the electric supercharger 4. In this second embodiment, the ECU 20 functions as the “supercharging control device” of the Claims by executing the control routine of FIG. 5.

### Embodiment #3

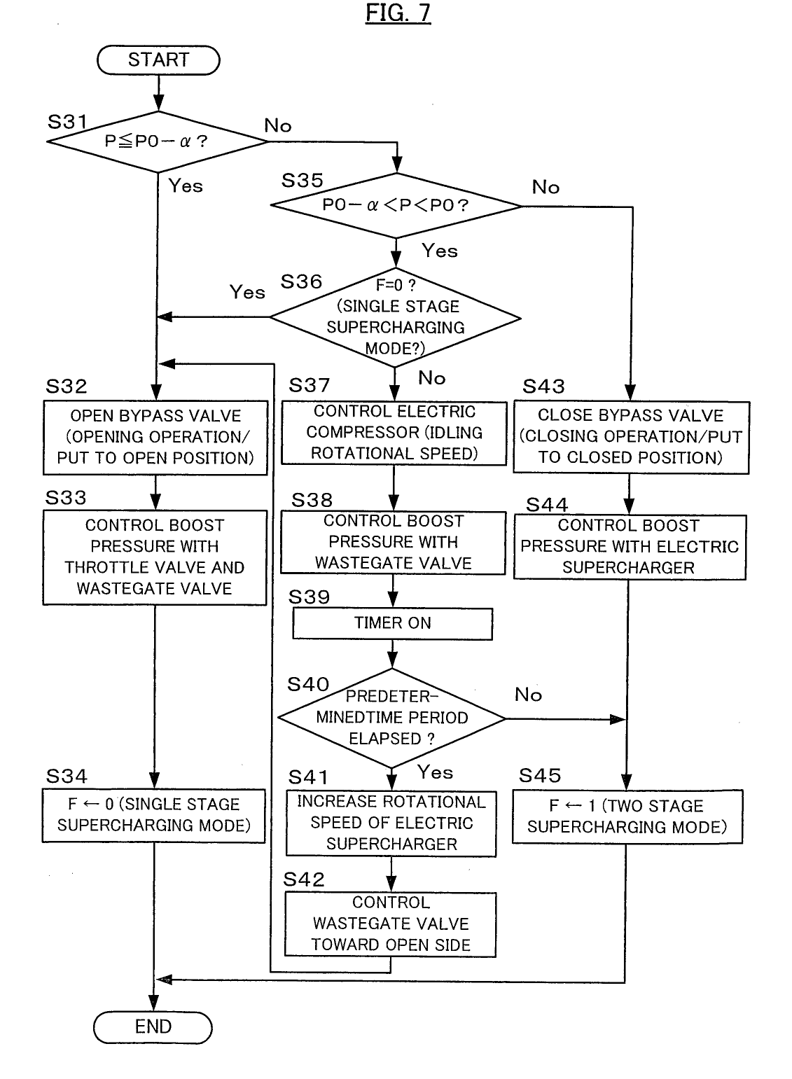

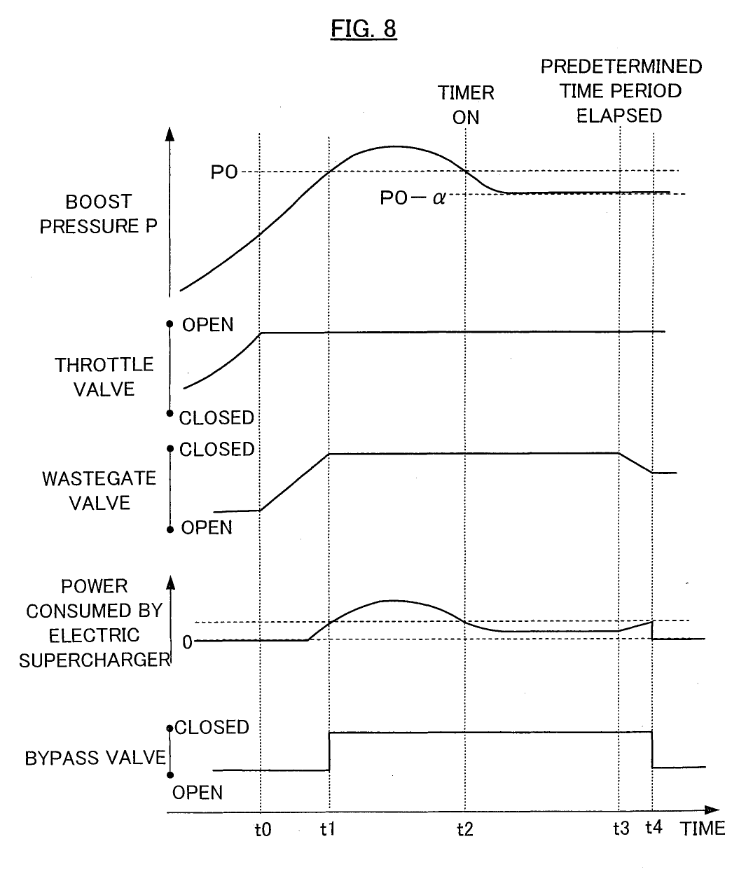

Next, a third embodiment of the present invention will be explained with reference to FIG. 7 and FIG. 8. Since, this third embodiment is the same as the first embodiment except for the details of the control, accordingly reference should be made to FIG. 1 for the physical structure of this third embodiment, and the explanation of the first embodiment should be referred to for explanation of that physical structure.

The program of the control routine shown in FIG. 7 is read out from storage by the ECU 20 in a timely manner and is repeatedly executed at predetermined intervals. In a step S31, the ECU 20 refers to the signal from the pressure sensor 11, and makes a decision as to whether or not the current boost pressure P is less than or equal P0−α, which is a value that is less than a threshold value P0 by a hysteresis amount α. If the boost pressure P is less than or equal P0−α then the flow of control proceeds to a step S32, whereas if it is not then the flow of control is transferred to a step S35.

In the step S32, the ECU 20 controls the bypass valve 13 so as to put it to the open position. In a step S33 the ECU 20 controls the boost pressure to a target value by controlling the opening amounts of the throttle valve 10 and of the wastegate valve 16. And next in a step S34 the ECU 20 sets a management flag F to “0”, which means the single stage supercharging mode.

In the step S35, the ECU 20 makes a decision as to whether or not the boost pressure P is greater than P0−α and also is smaller than P0. If indeed the boost pressure P is greater than P0−α and also is smaller than P0, then the flow of control proceeds to a step S36, whereas if it is not, in other words if the boost pressure P has reached the threshold value P0, then the flow of control is transferred to a step S43.

In the step S36, the ECU 20 makes a decision as to whether or not the current supercharging mode is the single stage supercharging mode, in other words as to whether or not the flag F=0. If the current mode is the single stage supercharging mode then the flow of control is transferred to the step S32, whereas if it is not, in other words if the current mode is the two stage supercharging mode, then the flow of control proceeds to the step S37.

In this step S37, the ECU 20 acquires the intake air amount on the basis of the signal from the air flow meter 14, and, on the basis of this intake air amount, controls the electric supercharger 4 so that it is kept at an idling rotational speed at a level at which there is no intake resistance. And then in a step S38 the ECU 20 controls the opening amount of the wastegate valve 16 to the open side, and thereby adjusts the boost pressure.

In a step S39, the ECU 20 turns an internal timer ON, and this timer starts to measure time. In a step S40, the ECU 20 makes a decision as to whether or not a predetermined time interval has elapsed from when the timer was turned ON, and if this predetermined time interval has elapsed then the flow of control proceeds to a step S41, whereas if it has not yet elapsed then the flow of control is transferred to a step S45. Although this predetermined time interval may be set as appropriate, one preferred method is to acquire the charge ratio of the battery 5 by referring to the signal from the SOC sensor 22, and to set this predetermined time interval to be longer, the higher this charge ratio is. By doing this, it becomes possible to set the time interval according to the level of necessity for reduction of electrical power consumption.

In a step S41, the ECU 20 increases the rotational speed of the electric supercharger 4 to a predetermined value. And next in a step S42 the ECU 20 operates the wastegate valve 16 toward the open side, so as to cancel out the increase of the boost pressure that accompanies this increase of the rotational speed of the electric supercharger 4.

In a step S43, the ECU 20 controls the bypass valve 13 to the closed position. In a step S44 the ECU 20 controls the boost pressure by operating the electric supercharger 4 as appropriate. In a step S45 the ECU 20 sets the management flag F to “1”, which means the two stage supercharging mode.

An example of the control results provided by the control routine of FIG. 7 will now be explained on the basis of the timing chart shown in FIG. 8. As shown in FIG. 8, from the time point t0, the opening amount of the throttle valve 10 (i.e. the throttle opening amount) becomes almost constant, so that the vehicle is operating in a stationary state or a quasi-stationary state. Thereafter, the boost pressure P is raised by controlling the opening amount of the wastegate valve 16 toward the closed side. And, when the boost pressure P reaches the threshold value P0 at the time point t1, the bypass valve 13 performs closing operation from its open position to its closed position, and is kept at its closed position until the time point t3 (refer to the step S43 of FIG. 7). And, due to the electric supercharger 4 being driven electrically, the supercharging mode transitions to the two stage supercharging mode. It should be understood that, in consideration of the response delay of the electric supercharger 4 for performing supercharging, the timing for starting electrical driving of the electric supercharger 4 is set to be a little earlier than the time point t1 at which the boost pressure P arrives at P0.

The timer is turned to ON when the boost pressure P reaches the threshold value P0 at the time point t2, after it reverses to decreasing after having exceeded the threshold value P0 at the time point t1 (refer to the step S39 of FIG. 7). And, when the predetermined time interval elapses at the time point t3 while the boost pressure remains between the pressures P0 and P0−α, the rotational speed of the electric supercharger 4 increases, and the wastegate valve 16 is controlled toward the open side, so as to cancel out the increase of the boost pressure that accompanies this increase of the rotational speed of the electric supercharger 4. And then at the time point t4 the bypass valve 13 is opened from the closed position to the open position (refer to the step S32 of FIG. 7), and at the same time the electrical driving of the electric supercharger 4 is stopped and the supercharging mode transitions from the two stage supercharging mode to the single stage supercharging mode.

According to this third embodiment, in a similar manner to the case with the first embodiment, since the opening operation and the closing operation of the bypass valve 13 are performed at threshold values that are different from one another, accordingly it is possible to suppress the occurrence of hunting, which is caused by frequent opening and closing operation of the bypass valve 13 during steady operation or during quasi-steady operation. Moreover, if driving in the two stage supercharging mode with the boost pressure P between P0 and P0−α is continued for more than the predetermined time period, then the system changes over from the two stage supercharging mode to the single stage supercharging mode. Since, due to this, it is possible to avoid driving the electric supercharger 4 continuously over a long time period, accordingly it is possible to keep down the amount of electrical power consumed by driving the electric supercharger 4. Moreover in this case, along with increasing the rotational speed of the electric supercharger 4, also, after having performed operation to change the opening amount of the wastegate valve 16 toward the open side so that increase of the boost pressure along with this increase of the rotational speed is cancelled out, operation for stopping the electrical driving of the electric supercharger 4 and operation for opening the bypass valve 13 are implemented at the same time. Since, due to the above, the increase of the boost pressure together with increase of the rotational speed of the electric supercharger 4 is cancelled out, accordingly it is possible to change over the supercharging mode from the two stage supercharging mode to the single stage supercharging mode while still suppressing fluctuations of the output torque of the internal combustion engine 2. In this third embodiment, the ECU 20 functions as the “supercharging control device” of the Claims by executing the control routine of FIG. 7.

The present invention is not to be considered as being limited to the embodiments described above; it could be implemented in various different ways, provided that the scope of its essential concept is not departed from. In the embodiments described above, the boost pressure was employed as the parameter that was used for operating the bypass valve; but it would also be possible to substitute the rotational speed or the air intake amount of the internal combustion engine, instead of the boost pressure. Furthermore, as shown in FIG. 2, it would also be possible to employ a combination of these physical quantities as this parameter.

Moreover while, in the embodiments described above, the turbine bypass passage detouring around the turbine of the turbo charger and the wastegate valve were provided, and the boost pressure was controlled by operation of the wastegate valve, it would also be possible to implement the present invention in a form in which no such turbine bypass passage or wastegate valve are provided.

While, in the embodiments described above, the present invention was applied to internal combustion engines of the spark ignition type, it would also be possible to apply the present invention to an internal combustion engine of the compression self-ignition type.

1. A supercharging system applied to an internal combustion engine, comprising:
a turbo supercharger that is driven by a turbine powered by an exhaust of the engine;
an electric supercharger that is electrically powered;
a bypass passage that bypasses the electric supercharger and connects an upstream side and a downstream side of the electric supercharger;
a bypass valve that is provided for opening and closing the bypass passage, and that operates between an open position in which it opens the bypass passage and a closed position in which it closes the bypass passage; and
a computer, wherein
the computer functions by executing a computer program as a supercharging control device which is configured to change over the supercharging mode between: a single stage supercharging mode in which the internal combustion engine is only supercharged by the turbo supercharger, due to electrical driving of said electric supercharger being stopped with the bypass valve in the open position; and a two stage supercharging mode in which the internal combustion engine is supercharged by both the turbo charger and the electric supercharger, due to electrical driving of the electric supercharger being performed with the bypass valve in the closed position;
wherein threshold values of a parameter that is employed for the supercharging control device to operate the bypass valve are different between a case of closing operation in which the bypass valve is operated from the open position to the closed position in order to change over from the single stage supercharging mode to the two stage supercharging mode, and a case of opening operation in which the bypass valve is operated from the closed position to the open position in order to change over from the two stage supercharging mode to the single stage supercharging mode.

2. A supercharging system according to claim 1, wherein the threshold values for the parameter that is employed for the supercharging control device to operate the bypass valve are different between the case of closing operation in which the bypass valve is operated from the open position to the closed position in order to change over from the single stage supercharging mode to the two stage supercharging mode, and the case of opening operation in which the bypass valve is operated from the closed position to the open position in order to change over from the two stage supercharging mode to the single stage supercharging mode, during steady operation or quasi-steady operation in which change over time of an operational state of the internal combustion engine is within a predetermined range.

3. A supercharging system according to claim 1, wherein the parameter is a rotational speed, an intake air amount, or a boost of the internal combustion engine; and the threshold value for the parameter for implementing the opening operation of the bypass valve is smaller than the threshold value for the parameter for implementing the closing operation of the bypass valve.

4. A supercharging system according to claim 1, wherein, if driving in the two stage supercharging mode has continued for longer than a predetermined time interval with a value of the parameter being between the threshold value for the parameter for implementing the opening operation of the bypass valve and the threshold value for the parameter for implementing the closing operation of the bypass valve, then the supercharging control device is configured to implements stopping of electrical driving of the electric supercharger, and also implement the opening operation of the bypass valve.

5. A supercharging system according to claim 1, further comprising a turbine bypass passage that bypasses the turbine of the turbo charger and connects between an upstream side and a downstream side of the turbine, and a wastegate valve that is provided in the turbine bypass passage and is capable of varying its opening amount from a position in which it fully closes the turbine bypass passage and a position in which it fully opens the turbine bypass passage; and wherein, when driving in the two stage supercharging mode is implemented between the threshold value for the parameter for implementing the opening operation of the bypass valve and the threshold value for the parameter for implementing the closing operation of the bypass valve, then the supercharging control device is configured to adjusts a boost pressure by operating the wastegate valve.

6. A supercharging system according to claim 1, further comprising a turbine bypass passage that bypasses the turbine of the turbo charger and connects between an upstream side and a downstream side of the turbine, and a wastegate valve that is provided in the turbine bypass passage and is capable of varying its opening amount from a position in which it fully closes the turbine bypass passage and a position in which it fully opens the turbine bypass passage; and wherein, when driving in the two stage supercharging mode is implemented between the threshold value for the parameter for implementing the opening operation of the bypass valve and the threshold value for the parameter for implementing the closing operation of the bypass valve, then the supercharging control device is configured to adjusts a boost pressure by operating the electric supercharger, while keeping an operational state of the wastegate valve in the position in which it fully closes the turbine bypass passage.

7. A supercharging system according to claim 6, wherein, if the operational state of the wastegate valve in the position in which it fully closes the turbine bypass passage has continued for longer than a predetermined time interval, then the supercharging control device is configured to increases a rotational speed of the electric supercharger, and, after having operated the wastegate valve towards its open side so that an increase of the boost pressure due to this increase of the rotational speed of the electric supercharger is cancelled, then simultaneously stops the electrical driving of the electric supercharger and performs opening operation of the bypass valve.
